(19) United States
(12) Patent Application Publication
(10) Pub. No.: US 2025/0209831 A1
(43) Pub. Date: Jun. 26, 2025

(54) ROAD DISEASE RECOGNITION METHOD, SYSTEM, DEVICE, AND STORAGE MEDIUM

(71) Applicant: Sinoroad Tranportaiton Science and Technology Co.,Ltd, Nanjing (CN)

(72) Inventors: Yongsheng GUAN, Nanjing (CN); Yang YANG, Nanjing (CN); Zhixiang ZHANG, Nanjing (CN); Qiang LIU, Nanjing (CN); Yong HU, Nanjing (CN)

(73) Assignee: Sinoroad Tranportaiton Science and Technology Co.,Ltd, Nanjing (CN)

(21) Appl. No.: 19/073,798

(22) Filed: Mar. 7, 2025

Related U.S. Application Data
(63) Continuation of application No. PCT/CN2023/080853, filed on Mar. 10, 2023.

(30) Foreign Application Priority Data
Sep. 23, 2022 (CN) 2022111676544

(51) Int. Cl. G06V 20/56; G06T 7/50; G06T 7/60; G06V 10/26; G06V 10/44; G06V 10/764; G06V 10/774

(52) U.S. Cl. CPC G06V 20/588; G06T 7/50; G06T 7/60; G06V 10/26; G06V 10/44; G06V 10/764; G06V 10/774; G06T 2207/20081; G06T 2207/30256

(57) ABSTRACT

The present invention relates to the technical field of artificial intelligence, and in particular, to a road disease recognition method, system, a device, and a storage medium. The road disease recognition method includes: collecting a historical pavement image with a disease, and sequentially detecting and segmenting the historical pavement image to generate a plurality of visualized sample images, where the sample images have feature parameters marking the sample images; establishing a sample training set using the sample images; building a discriminative model for determining a disease category, and training the discriminative model using the sample training set to obtain a trained discriminative model; acquiring a new pavement image, sequentially detecting and segmenting the new pavement image, and then inputting the new pavement image that is detected and segmented into the discriminative model to generate a determination result.

### CROSS-REFERENCE TO RELATED APPLICATIONS

The application claims priority to Chinese patent application No. 2022111676544, filed on Sep. 23, 2022, the entire contents of which are incorporated herein by reference.

### TECHNICAL FIELD

The present invention relates to the technical field of artificial intelligence, and in particular, to a road disease recognition method, system, a device, and a storage medium.

### BACKGROUND

Existing road disease detection technologies are typically limited to the detection of road cracks. However, road diseases include various types such as cracks, potholes, and looseness, rather than being confined to a single type of road cracks. Different types of road diseases require different repair methods. Therefore, the detection and classification of various road diseases are essential for the repair of road diseases.

Most existing road disease recognition technologies utilize semantic segmentation, which is a technology that classifies image pixels. However, the semantic segmentation technology is prone to generating noisy regions, interferes with accurate localization, and has insufficient semantic information, potentially leading to low accuracy of final semantic segmentation results and poor segmentation effect.

The information disclosed in this Background section is intended solely to enhance the understanding of the overall background technology of the present disclosure, and should not be construed as an acknowledgment or implication in any form that this information constitutes the prior art known to those skilled in the art.

### SUMMARY

A technical problem to be solved by the present invention is to provide a road disease recognition method, system, a device, and a storage medium, which can perform disease recognition and analysis on video data of a road in real time, recognize and mark a disease region, and facilitate subsequent maintenance of the road by construction personnel.

To achieve the above purpose, the present invention adopts the following technical solution: a road disease recognition method, including:
collecting a historical pavement image with a disease, and sequentially detecting and segmenting the historical pavement image to generate a plurality of visualized sample images, where the sample images have feature parameters marking the sample images;
establishing a sample training set using the sample images;
building a discriminative model for determining a disease category, and training the discriminative model using the sample training set to obtain a trained discriminative model;
acquiring a new pavement image, sequentially detecting and segmenting the new pavement image, and then inputting the new pavement image that is detected and segmented into the discriminative model to generate a determination result; and
if the disease is determined to be a crack, calculating a width of the crack, and if the disease is determined to be a pothole or a rut, calculating a depth of the pothole or the rut.

Further, the feature parameters include the disease category, a relative position of the disease, a confidence level, and a disease instance segmentation region.

Further, the disease category includes a crack, a rut, a pothole, looseness, flushing asphalt, and repairing.

Further, the pavement image is derived from a video captured by a vehicle-mounted camera and is obtained through the following steps: reading an image in a video frame, cropping the image of the frame, and performing feature extraction on a cropped image to obtain the pavement image.

Further, a method for calculating the width of the crack specifically includes the following steps:
A1: if the disease is determined to be a crack, determining an instance segmentation region;
A2: determining edge lines and a central axis of the instance segmentation region;
A3: determining a center point list based on the central axis;
A4: taking a center point, searching for coordinate points of two nearest edge lines, and calculating a width value; and
A5: repeating the step A4 until width values corresponding to all center points in the center point list are calculated, and calculating a mean width value.

Further, a method for calculating the depth of the pothole specifically includes the following steps:
B1: if the determination result is a pothole type, determining instance segmentation regions;
B2: using a camera application to convert a depth heat map based on the instance segmentation regions;
B3: determining extrinsic parameters of a camera, calculating an extrinsic parameter matrix of the camera, and correcting a depth coefficient;
B4: for all instance segmentation regions, determining to remove singularities, and obtaining coordinates of all non-singularities and corresponding depth values; and
B5: calculating a mean depth of a pothole region based on the coordinates of all non-singularities and the corresponding depth values that are obtained.

Further, while generating the pavement image, it is also necessary to obtain geographic coordinate information sent by a vehicle-mounted positioning device, and save a determination result generated based on the pavement image together with the geographic coordinate information to a vehicle-mounted terminal and/or send same directly to a terminal device of maintenance personnel by means of wireless transmission.

The present invention further discloses a road disease recognition system, including:
a data preprocessing module, configured to collect a historical pavement image with a disease, and sequentially detect and segment the historical pavement image to generate a plurality of visualized sample images, where the sample images have feature parameters marking the sample images;
a sample dataset establishment module, configured to establish a sample training set using the sample images;
a model generation module, configured to build a discriminative model for determining a disease category, and train the discriminative model using the sample training set to obtain a trained discriminative model;
a determination module, configured to acquire a new pavement image, sequentially detect and segment the new pavement image, and then input the new pavement image that is detected and segmented into the discriminative model to generate a determination result; and
a result post-processing module, configured to: if the disease is determined to be a crack, calculate a width of the crack, and if the disease is determined to be a pothole or a rut, calculate a depth of the pothole or the rut.

Further, the road disease recognition system further includes an image processing module, where the image processing module is configured to read an image of a video frame, crop the image of the frame, and perform feature extraction on a cropped image.

On the other hand, the present invention further discloses an electronic device, including: at least one processor; and
a memory in communication connection with the at least one processor, where
the memory stores instructions that can be executed by the at least one processor, and the instructions are executed by the at least one processor to cause that the at least one processor can perform the method described in any of the preceding items.

On the other hand, the present invention further discloses a storage medium, where the computer storage medium has a computer program stored thereon, and the computer program is configured to cause a computer to perform the method described in any of the preceding items.

The beneficial effects of the present invention are as follows:
(1) in addition to road crack detection, the present invention also incorporates various types of road diseases, such as potholes and looseness of roads, making the recognition of the road diseases more specific and comprehensive;
(2) the present invention obtains information such as the width of the cracks and the depth of the potholes by segmenting the disease region, and grades the road diseases while recognizing the road diseases, thus facilitating the maintenance of the road by the construction personnel;
(3) different from a semantic segmentation means in the prior art, the present invention adopts an instance segmentation technology of performing detection first and segmentation second to ensure accurate positioning and complete segmentation information; and
(4) different from most existing road disease recognition systems that rely on desktop client driving and can only recognize image data, the system of the present invention is deployed on an edge device, and can be mounted on vehicles in the form of an all-in-one machine to obtain real-time video data of the road for disease recognition and analysis during vehicle driving. Compared to other road disease recognition systems, the present invention is more flexible and easy to deploy, and can achieve real-time disease visualization.

### BRIEF DESCRIPTION OF THE DRAWINGS

To explain the technical solutions in embodiments of the present invention or in the prior art more clearly, the drawings used in the embodiments or the prior art will be briefly introduced below. It is obvious that the drawings in the following description are only some embodiments recorded in the present invention, and those ordinarily skilled in the art would have been able to obtain other drawings according to these drawings without creative work.

FIG. 1 is an effect diagram of semantic segmentation adopted in a background technology;

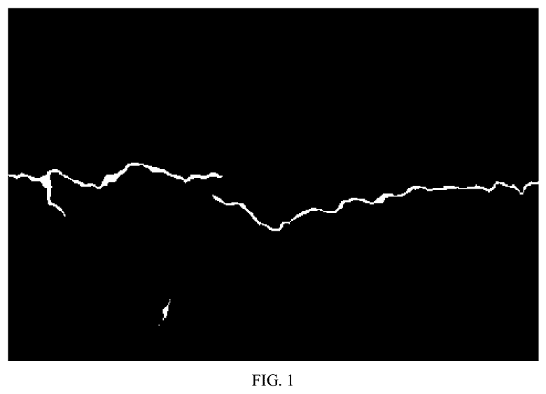

FIG. 2 is a flowchart of a road disease recognition method according to an embodiment of the present invention;

FIG. 3 is an architecture diagram of a road disease recognition method according to an embodiment of the present invention;

FIG. 4 is an effect diagram obtained after detecting and segmenting an image according to an embodiment of the present invention;

FIG. 5 is a flowchart of calculating a width of a crack according to an embodiment of the present invention;

FIG. 6 is a first effect diagram for displaying calculation of a width of a crack according to an embodiment of the present invention;

FIG. 7 is a second effect diagram for displaying calculation of a width of a crack according to an embodiment of the present invention;

FIG. 8 is a third effect diagram for displaying calculation of a width of a crack according to an embodiment of the present invention;

FIG. 9 is a flowchart of calculating a depth of a pothole according to an embodiment of the present invention; and

FIG. 10 is an architecture diagram of a road disease recognition system according to an embodiment of the present invention.

### DETAILED DESCRIPTION OF THE EMBODIMENTS

The following clearly and completely describes the technical solutions in the embodiments of the present invention with reference to the accompanying drawings in the embodiments of the present invention. Apparently, the described embodiments are merely some rather than all of the embodiments of the present invention.

It should be noted that, when an element is described to be “fixed to” another element, it may be directly positioned on another element or there may be a centered element. When an element is referred to as being “connected to” another element, it may be directly connected to another element or there may additionally be a centered element.

The terms “vertical”, “horizontal”, “left”, “right” and similar expressions used herein are for illustrative purposes only and not intended to be expressed as the only embodiment.

Unless otherwise defined, all technical and scientific terms used herein have the same meaning as those commonly understood by a person skilled in the art of the present invention. The terms used in the specification of the present invention are merely for the purpose of describing specific embodiments, but are not intended to limit the present invention. The term “and/or” used herein includes any and all combinations of one or more of the relevant listed items.

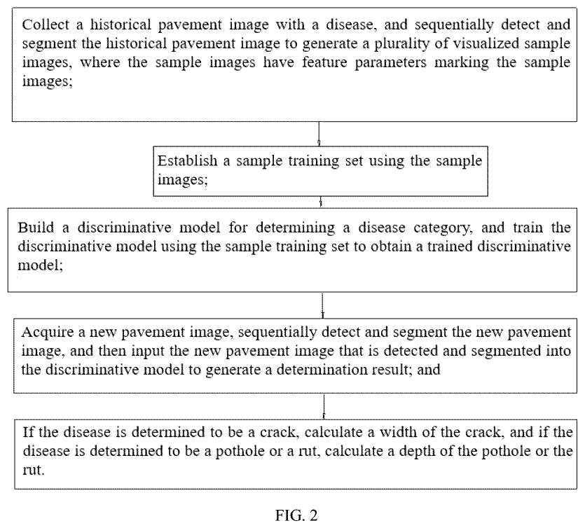

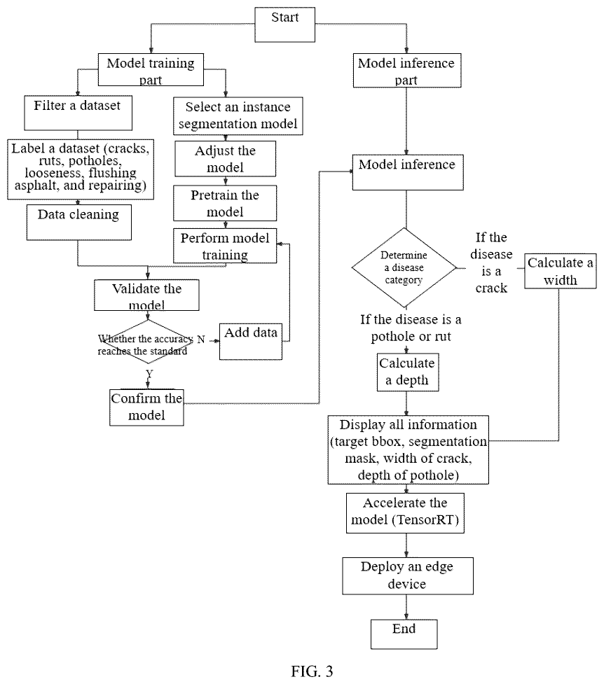

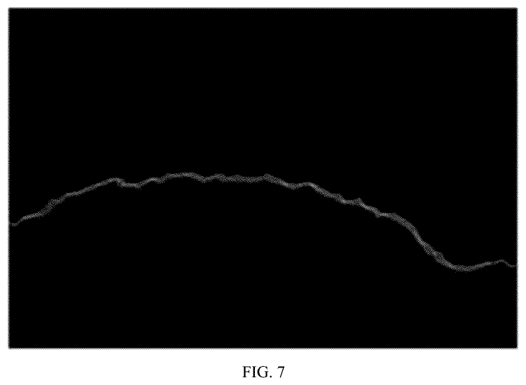

As shown in FIG. 2 to FIG. 9, a road disease recognition method, including:
collecting a historical pavement image with a disease, and sequentially detecting and segmenting the historical pavement image to generate a plurality of visualized sample images, where the sample images have feature parameters marking the sample images;
establishing a sample training set using the sample images;
building a discriminative model for determining a disease category, and training the discriminative model using the sample training set to obtain a trained discriminative model;
acquiring a new pavement image, sequentially detecting and segmenting the new pavement image, and then inputting the new pavement image that is detected and segmented into the discriminative model to generate a determination result; and
if the disease is determined to be a crack, calculating a width of the crack, and if the disease is determined to be a pothole or a rut, calculating a depth of the pothole or the rut.

The recognition method provided by the present invention is implemented using an algorithm, and the algorithm is deployed in a nvidia jetson NX edge computing platform as a whole, which is lightweight and convenient, and is easy to be deployed in any vehicle model, while the collection of the pavement images is performed through real-time shooting by a camera, and a RealSense D435 depth camera is selected as the camera.

According to the recognition method provided by the present invention, historical pavement images with different diseases are collected as data sources, and the pavement images are detected and segmented through YOLACT. YOLACT is a model for real-time instance segmentation, which performs instance segmentation through two parallel sub-networks. Compared to traditional instance segmentation models, YOLACT has only a slight loss of accuracy, but greatly improves the speed of segmentation.

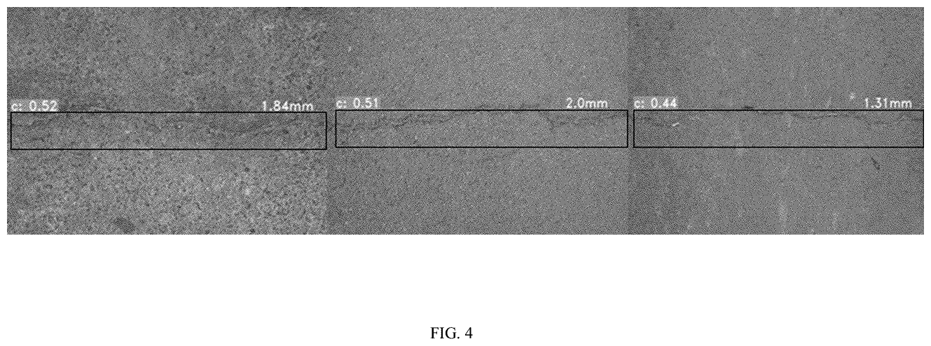

As shown in FIG. 4, after detection and instance segmentation, the pavement image is converted into a plurality of visualized sample images, each sample image has feature parameters marking the sample image, and part of the sample images are selected to establish a sample training set and build a discriminative model, and the sample training set is used to train the discriminative model. A specific model building process is as follows:
step 1: loading information in the sample images and labels, converting to a format recognizable by the model, normalizing data, and initializing model parameters;
step 2: inputting the sample training set into the discriminative model, and outputting a feature list containing four types of information: a disease category, a relative position of the disease, a confidence level, and a disease instance segmentation region;
step 3: inputting the feature list and the labels into a loss function to calculate a loss; and
step 4: adjusting the parameters through backpropagation to validate the model until the model converges.

To establish a good recognition model, the accuracy of model recognition needs to be verified. The confirmation of the accuracy can be manually rechecked to sieve out accurate and inaccurate data, so as to calculate the accuracy. In case of low accuracy, the sample images that are not used previously need to be selected to perform continuous training until the accuracy of the model is recognized to reach the standard, and subsequently, a trained recognition model is obtained.

Next, the recognition model is applied to actual usage environments, a new pavement video is obtained in real time using a vehicle-mounted camera, a video frame is read, and an image of the frame is cropped into a size of (640, 640) or (320, 320);
the cropped images ate input into a network feature extraction module for feature extraction, and then are separately placed into a detection module and a segmentation module in YOLACT;
a detection module part is sequentially placed into a Neck module and a PANet module to obtain prediction results, and then a non-maximum suppression (NMS) operation is performed on anchor to select a BBox result with highest quality;
for a segmentation module part, Protonet is used to perform pixel level classification on features extracted from network to obtain a segmentation heat map;
the obtained BBox results are all reduced to the segmentation heat map according to a sale, and the segmentation heat map is cropped according to the BBox results;
a cropped segmentation heat map is subjected to thresholding processing to obtain segmentation masks; and
corresponding Bbox results and segmentation masks are restored in proportion to an original image and placed in corresponding positions of the original image for display.

Specific disease categories include cracks, ruts, potholes, looseness, flushing asphalt, and repairing. Among them, the cracks, the ruts, and the potholes need to be repaired based on their specific level of damage. For example, if the disease is determined to be a crack, a width of the crack is calculated, and if the disease is determined to be a pothole or rut, a depth of the pothole or rut is calculated. The present application grades the road diseases while recognizing the road diseases, thus facilitating the maintenance of the road by the construction personnel.

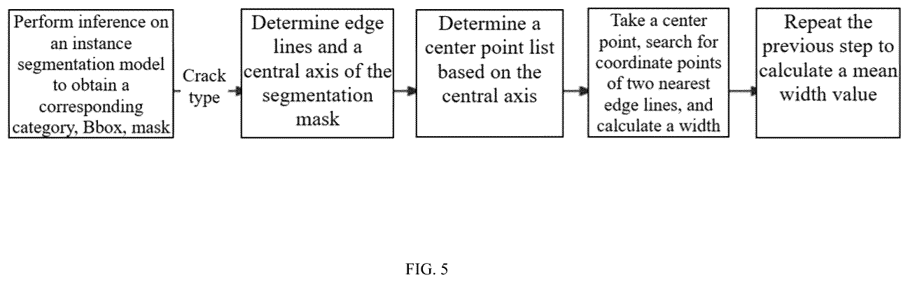

As a specific disclosure of the above embodiment, as shown in FIG. 5, a method for calculating the width of the crack specifically includes the following steps:
A1: if the disease is determined to be a crack, determining an instance segmentation region;
A2: determining edge lines and a central axis of the instance segmentation region using a Sobel operator method and a principal axis transformation method;
A3: determining a center point list based on the central axis;
A4: taking a center point, finding a K-nearest neighbor point of a given point using a kd-tree algorithm, then using singular value decomposition to calculate a normal vector of a skeleton line, determining an orthogonal slope based on the normal vector, and searching for coordinate points of two nearest edge lines so as to calculate a width value;
A5: repeating the step A4 until width values corresponding to all center points in the center point list are calculated, and calculating a mean width value.

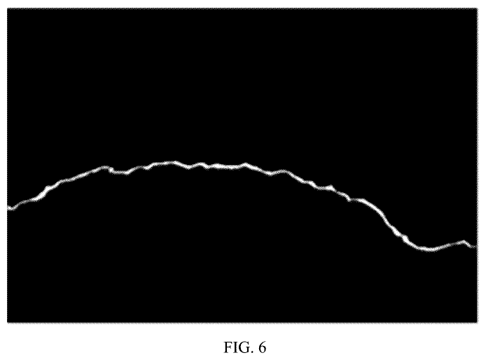

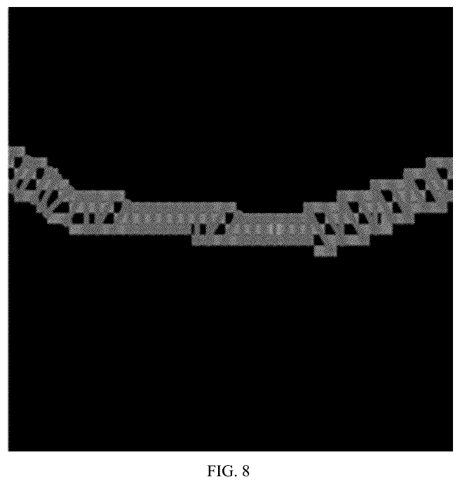

FIG. 6 to FIG. 8 show a whole process of image processing performed by the algorithm. After determining that the disease is a crack type, a width value in a whole length direction is obtained by calculating the edge lines and the central axis in FIG. 8. After that, mean value calculation is performed to obtain a mean width value, and the width of the crack is graded according to the mean width value, and thus the damages of different cracks can be fed back by setting different threshold ranges.

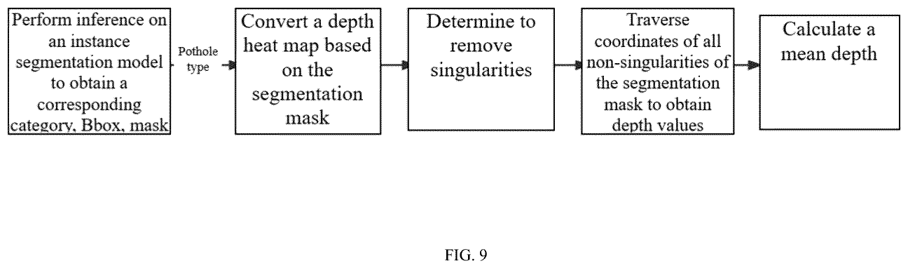

As a specific disclosure of the above embodiment, as shown in FIG. 9, a method for calculating the depth of the pothole specifically includes the following steps:
B1: if the determination result is a pothole type, determining instance segmentation regions;
B2: using a camera application to convert a depth heat map based on the instance segmentation regions;
B3: determining extrinsic parameters of a camera, calculating an extrinsic parameter matrix of the camera, and correcting a depth coefficient;
B4: for all instance segmentation regions, determining to remove singularities, and obtaining coordinates of all non-singularities and corresponding depth values; and
B5: calculating a mean depth of a pothole region based on the coordinates of all non-singularities and the corresponding depth values that are obtained.

When the determination result is a rut type, a method for calculating a depth of a rut is equivalent to the method for calculating the depth of the pothole. By adopting the above calculation method, a mean depth of the pothole can be calculated; the depth of the pothole can be graded according to a mean depth value; and the damages of different potholes can be fed back by setting different threshold ranges.

As a preferred embodiment of the above embodiments, while generating the pavement image, it is also necessary to obtain geographic coordinate information sent by a vehicle-mounted positioning device, and save a determination result generated based on the pavement image together with the geographic coordinate information to a vehicle-mounted terminal and/or send same directly to a terminal device of maintenance personnel by means of wireless transmission. In this way, the image and the coordinate information are linked, thus facilitating later finding of specific positions of the diseases. Specific implementations can refer to the prior art and will not be repeated here.

Those skilled in the art should understand that the embodiments of the present application may be provided as a method, an apparatus, a storage medium or an electronic device product, and thus the embodiments of the present application may be entirely hardware embodiments, embodiments combining hardware and software, or purely software embodiments. The following describes a real-time monitoring apparatus for a moving object in the embodiments of the present application, and apparatus embodiments hereinafter correspond to method embodiments hereinabove. Those skilled in the art can understand the implementation process hereinafter based on the description hereinabove, and a detailed description will not be repeated here.

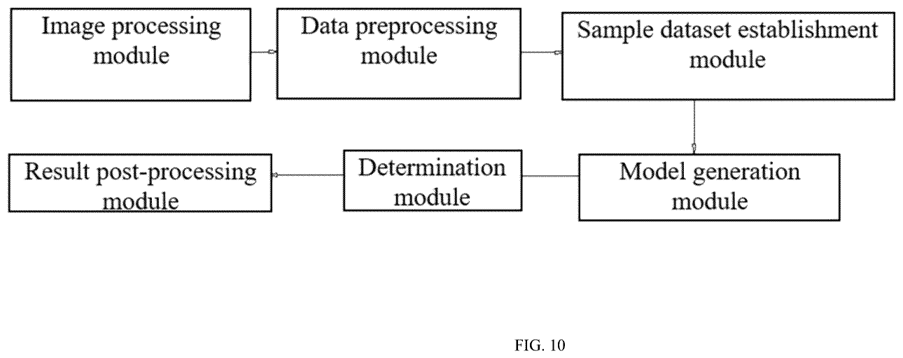

As shown in FIG. 10, this embodiment further provides a road disease recognition system, including:
a data preprocessing module, configured to collect a historical pavement image with a disease, and sequentially detect and segment the historical pavement image to generate a plurality of visualized sample images, where the sample images have feature parameters marking the sample images;
a sample dataset establishment module, configured to establish a sample training set using the sample images;
a model generation module, configured to build a discriminative model for determining a disease category, and train the discriminative model using the sample training set to obtain a trained discriminative model;
a determination module, configured to acquire a new pavement image, sequentially detect and segment the new pavement image, and then input the new pavement image that is detected and segmented into the discriminative model to generate a determination result; and
a result post-processing module, configured to: if the disease is determined to be a crack, calculate a width of the crack, and if the disease is determined to be a pothole or a rut, calculate a depth of the pothole or the rut.

Further, the road disease recognition system further includes an image processing module, where the image processing module is configured to read an image of a video frame, crop the image of the frame, and perform feature extraction on a cropped image.

In the following description of the embodiments of the present invention, embodiments of the computer storage medium and the electronic device in the embodiments of the present invention are introduced. Embodiments of the computer storage medium and the processor hereinafter correspond to the method embodiments hereinabove. Those skilled in the art can understand the implementation process hereinafter based on the description hereinabove, and a detailed description will not be repeated here.

Another aspect of the embodiments of the present invention further provides an electronic device, including: at least one processor; and a memory in communication connection with the at least one processor, where
the memory stores instructions that can be executed by the at least one processor, and the instructions are executed by the at least one processor to cause that the at least one processor can perform the method described in any of the preceding items.

Such an electronic device can be deployed on hosts such as an edge device side NX, AGX on a vehicle. Such hosts are loaded with a linux system for development. When the edge device side performs an operation process, since the trained network model may be very large and have many parameters, and there are differences in machine performance of deployment sides, slow inference speed and high latency are caused, which is fatal for application scenarios that require high real-time performance. Therefore, further, this embodiment further discloses TensorRT, where TensorRT is a high-performance deep learning inference optimizer which can provide a deployment inference with low latency and high throughput for deep learning applications. TensorRT can be used to accelerate the inference for hyperscale data centers, embedded platforms or autonomous driving platforms.

A process for accelerating the model through TensorRT is as follows:
(1) TensorRT installation: confirming a CUDA version of a device;
(2) converting a trained model from a pytorch model to a general ONNX format;
(3) a bulid phase: converting a model in the ONNX format to a TensorRT model for acceleration and deployment, where inter-layer fusion and accuracy calibration of the aforementioned optimization process are completed during model conversion; an output of this step is an optimized TensorRT model for a specific GPU platform and a network model, and the TensorRT model can be serialized and stored on a disk or in a memory; and
(4) a deploy phase: testing an engine model, where the deploy phase mainly completes an inference process, Kernel Auto-Tuning and Dynamic Tensor Memory are completed here. A model file in the previous step is first deserialized and a runtime engine is created, then data (such as pictures outside a test set or a dataset) can be input, and then a classification vector result or a detection result can be output. After processes of deployment, optimization, and testing, a final instance segmentation model can achieve a real-time and efficient recognition effect at the edge device side.

Another aspect of the embodiments of the present invention further provides a computer storage medium, where the computer storage medium has a computer program stored thereon, and the computer program is configured to cause a computer to perform the method described in any of the preceding items.

Those skilled in the art should understand that the present invention is not limited to the above embodiments, the descriptions in the above embodiments and specification are merely to illustrate the principles of the present invention, and various changes and improvements may be made to the present invention without departing from the spirit and scope of the present invention. These changes and improvements shall fall within the scope of protection claimed in the present invention. The scope of protection claimed in the present invention is defined by the appended claims and equivalents thereof.

What is claimed is:

1. A road disease recognition method, comprising:
collecting a historical pavement image with a disease, and sequentially detecting and segmenting the historical pavement image to generate a plurality of visualized sample images, wherein the sample images have feature parameters marking the sample images;
establishing a sample training set using the sample images;
building a discriminative model for determining a disease category, and training the discriminative model using the sample training set to obtain a trained discriminative model;
acquiring a new pavement image, sequentially detecting and segmenting the new pavement image, and then inputting the new pavement image that is detected and segmented into the discriminative model to generate a determination result; and
if the disease is determined to be a crack, calculating a width of the crack, and if the disease is determined to be a pothole or a rut, calculating a depth of the pothole or the rut.

2. The road disease recognition method according to claim 1, wherein the feature parameters comprise the disease category, a relative position of the disease, a confidence level, and a disease instance segmentation region.

3. The road disease recognition method according to claim 1, wherein the disease category comprises a crack, a rut, a pothole, looseness, flushing asphalt, and repairing.

4. The road disease recognition method according to claim 1, wherein the pavement image is derived from a video captured by a vehicle-mounted camera and is obtained through the following steps: reading an image in a video frame, cropping the image of the frame, and performing feature extraction on a cropped image to obtain the pavement image.

5. The road disease recognition method according to claim 1, wherein a method for calculating the width of the crack specifically comprises the following steps:
A1: if the disease is determined to be a crack, determining an instance segmentation region;
A2: determining edge lines and a central axis of the instance segmentation region;
A3: determining a center point list based on the central axis;
A4: taking a center point, searching for coordinate points of two nearest edge lines, and calculating a width value; and
A5: repeating the step A4 until width values corresponding to all center points in the center point list are calculated, and calculating a mean width value.

6. The road disease recognition method according to claim 1, wherein a method for calculating the depth of the pothole specifically comprises the following steps:
B1: if the determination result is a pothole type, determining instance segmentation regions;
B2: using a camera application to convert a depth heat map based on the instance segmentation regions;
B3: determining extrinsic parameters of a camera, calculating an extrinsic parameter matrix of the camera, and correcting a depth coefficient;
B4: for all instance segmentation regions, determining to remove singularities, and obtaining coordinates of all non-singularities and corresponding depth values; and
B5: calculating a mean depth of a pothole region based on the coordinates of all non-singularities and the corresponding depth values that are obtained.

7. A road disease recognition system, comprising:
a data preprocessing module, configured to collect a historical pavement image with a disease, and sequentially detect and segment the historical pavement image to generate a plurality of visualized sample images, wherein the sample images have feature parameters marking the sample images;
a sample dataset establishment module, configured to establish a sample training set using the sample images;
a model generation module, configured to build a discriminative model for determining a disease category, and train the discriminative model using the sample training set to obtain a trained discriminative model;
a determination module, configured to acquire a new pavement image, sequentially detect and segment the new pavement image, and then input the new pavement image that is detected and segmented into the discriminative model to generate a determination result; and
a result post-processing module, configured to: if the disease is determined to be a crack, calculate a width of the crack, and if the disease is determined to be a pothole or a rut, calculate a depth of the pothole or the rut.

8. The road disease recognition system according to claim 7, further comprising an image processing module, wherein the image processing module is configured to read an image of a video frame, crop the image of the frame, and perform feature extraction on a cropped image.

9. An electronic device, comprising: at least one processor; and
a memory in communication connection with the at least one processor, wherein
the memory stores instructions that can be executed by the at least one processor, and the instructions are executed by the at least one processor to cause that the at least one processor can perform the method according to claim 1.
